(19) United States
(12) Patent Application Publication
(10) Pub. No.: US 2018/0077227 A1
(43) Pub. Date: Mar. 15, 2018

(54) High Volume Traffic Handling for Ordering High Demand Products

(71) Applicants: Oleg Yeshaya Ryaboy, Hopkins, MN (US); Amit Bartake, Maple Grove, MN (US); Ian Holsman, Richmond (AU); Ryan Patrick Douglas, Edina, MN (US); Christopher Joseph Rence, Balsam Lake, WI (US)

(72) Inventors: Oleg Yeshaya Ryaboy, Hopkins, MN (US); Amit Bartake, Maple Grove, MN (US); Ian Holsman, Richmond (AU); Ryan Patrick Douglas, Edina, MN (US); Christopher Joseph Rence, Balsam Lake, WI (US)

(21) Appl. No.: 15/686,097

(22) Filed: Aug. 24, 2017

Related U.S. Application Data
(60) Provisional application No. 62/378,773, filed on Aug. 24, 2016.

(51) Int. Cl. H04L 29/08; G06Q 30/06; G06Q 10/08; H04L 12/26

(52) U.S. Cl. CPC H04L 67/1002; G06Q 30/0609; H04L 67/02; H04L 43/08; G06Q 10/087

(57) ABSTRACT

A light-weight system is employed to meter traffic into an ecommerce system when the expected level of traffic would cause performance instability and other issues. A distribution service system logically sits in front of the ecommerce system when traffic is or is expected to be extraordinarily high. Users complete a page form indicating interest in purchasing an item. High-speed logging of the request record is performed by the distribution service engine. Basic preliminary filter services are applied to the file with records failing preliminary checks flagged or removed. The remaining records are presented to a distribution engine. A distribution algorithm determines an optimal policy for allowing the users to place orders, specifying the particular time period allowed, which has the effect of metering orders into the system at a rate at which the system can continue to perform optimally.

### RELATED APPLICATIONS

This application claims the benefit of U.S. Provisional Application No. 62/378,773 filed 24 Aug. 2016, entitled “Traffic Handling for Protecting E-Commerce Sites,” which is incorporated herein by reference.

### FIELD OF THE INVENTION

The present disclosure relates to a system and method for efficiently managing spike loads of incoming ecommerce traffic, and in particular, during periods of high volume traffic/high demand in a distributed computing environment over the internet.

### BACKGROUND OF THE INVENTION

Occasionally, novel products are introduced into the marketplace with their demand far exceeding their supply. Take, for example, Apple's iPad and iPad2. These items were launched to crowds of consumers waiting outside stores for hours to purchase a limited supply of products. While the seller (i.e. manufacturer, retailer, etc.) may be overjoyed at the demand, such a situation does not create a good customer experience. Purchasers may stand in line for hours only to be told when they reach the counter that there are no products left for them. Anger flares when some consumers purchase multiple quantities for resale on internet auction sites or in foreign countries where the items are not available via legitimate markets, and leave those waiting in line behind them with nothing.

An ecommerce solution solves some of these problems. Rather than wait in line for hours with uncertain results, consumers may access an online store to purchase the item. The store may allow a purchaser to preorder an item in order to receive it when it hits the market. However, business, technical and functional challenges still exist, especially if the ecommerce system infrastructure and surrounding technology are not prepared to handle unusually high demand.

Periods during which online applications receive an exceptionally high volume of transactions, such as holidays or during preorder or release of long-awaited products, present a number of technical and user-experience related issues. As those of ordinary skill in the computer arts are aware, there are some general issues around traffic that all online applications face with being on the internet. Designing an online system involves designing for performance. Performance is impacted by the interest and interaction with the application online. Whereas a desktop application may involve just one user operating the software at a particular time, users of an online application may number several to millions of people at the same time.

Online applications are architected and sized for performance under normal or typical conditions and do not work well when traffic spikes. For example, the owner of a population of servers with information that is provided frequently to the internet will want that information to be cached in memory so that repeated access to that information is quick and inexpensive. Under load, that cache can benefit performance. However, if the system does not have enough traffic hitting the cache servers, enough to keep the cache “warm” (where cached items are frequently requested), then users who trickle into the site will have poor performance. So, when developers design and build an internet application, they build in an amount of cache and population of web servers that size to the amount of traffic that will normally be expected. That system is then tuned to expect that in most circumstances the users are getting the benefit of the cache. If a spike event occurs, a period of high volume, high demand on the system, the system breaks down.

It is unrealistic, in time and cost, to grow the size of the infrastructure to meet spike or high demand loads as they occur. System issues develop if the system is scaled to operate at the increased level of traffic. Referring again to the caching example above, once the traffic subsides the typical amount of traffic received will not induce the algorithms behind the scenes to keep the cache populated effectively. The infrastructure required for a spike event is poisonous to normal traffic and the infrastructure needed for normal traffic is insufficient to meet the needs of the spike.

For online commerce, poor performance of a web store is associated with a very low close rate. Although users are not physically standing in line, they are in a very real, electronic queue. An electronic queue may be even more congested than a physical queue because of the centralized nature of ecommerce purchasing and the system issues discussed above, resulting in connectivity or communication problems if the system is not sufficiently robust. A high volume of requests headed for the same web server must pass through the network, the network interface to the server and the server's operating system prior to getting to the web server itself. An overload of requests may cause issues at any one of these points, frustrating the user's efforts to get to the destination web server. An overload of requests hitting the web server will result in an unwanted error page presented to a user, who may give up trying to access the site in frustration, or just forget to come back later. If limits are placed on the quantity that may be purchased, the user must not lose his place in queue or he risks losing the item, and the merchant risks losing the sale. Finally, once stock is depleted, the seller may lose any information on the user, who may not be willing to come back when more stock is available.

Due to the constraints and issues around internet communications, and real-time sizing of infrastructure to meet demand (e.g. lack of time and capital), an e-commerce merchant should be prepared with a system solution capable of handling a high volume of requests. The embodiments taught by the present disclosure solve these and other problems and offers other advantages over the prior art by providing an additional, integrated architecture that can handle spikes in requests and allow the user to interact in real time without expanding the basic internet commerce infrastructure.

### SUMMARY

Embodiments described herein are directed to a system and method for protecting an online commerce system from instability during periods of exceptionally high volumes of traffic, including those that occur when a popular product is released or available for preorder. Protection is provided by capturing details of order requests as users access the system, and subjecting them to a distribution algorithm that allows users to return at a predetermined time slot to place an order, thus metering the traffic at an acceptable level.

Embodiments consistent with this disclosure include a system for protecting an online ecommerce system from extraordinarily high traffic, comprising a first server associated with a website selling products or services of high demand, a second server associated with an ecommerce system, providing a full suite of ecommerce functions and configured for optimal performance at a normal rate of traffic, a third server associated with a distribution service logically placed in front of the ecommerce system during periods of very high traffic, the server comprising a processor, memory, and computer instructions stored in memory which when executed by the processor perform the method of metering traffic to the ecommerce system by receiving requests from a large number of users, the requests indicating user interest in purchasing a product for which expected traffic may exceed the performance limits of the second server, capturing request information and subjecting it to preliminary processing. A distribution algorithm is employed to determine the number and time that the users may access the ecommerce system to place an order, restricting the user to the allotted time in order to meter traffic into the ecommerce system at an acceptable rate.

Other aspects of the technology introduced here will be apparent from the accompanying figures and from the following descriptions.

### BRIEF DESCRIPTION OF THE DRAWINGS

FIG. 1 illustrates one of the possible system structures consistent with the practice of an embodiment of the disclosed system and method.

FIG. 2 is a diagram of the processes required to set up an embodiment of the disclosed system.

FIG. 3 is a flow chart of a process consistent with an embodiment of the disclosed system and method.

FIG. 4 illustrates the basic components of the computing systems used in an embodiment of the disclosed system and method.

### DETAILED DESCRIPTION

Embodiments of the claimed features will now be described more fully hereinafter with reference to the accompanying drawings, in which some, but not all, embodiments are shown. The various features and components may be combined in many different forms and should not be construed as limited to the embodiments set forth herein. Like numbers refer to the same elements throughout. Where possible, any terms expressed in the singular form herein are meant to also include the plural form and vice versa, unless explicitly stated otherwise. For reference, a seller provides items to sell to the general population online and may be a vendor, merchant, an ecommerce service client or an ecommerce service provider. A user is a customer or an end user. Within this specification, an ecommerce system may be referred to as a ‘commerce system;’ these terms are synonymous and indicate a system for providing order provisioning and fulfillment over the internet, including the entire suite of services required for conducting sales online.

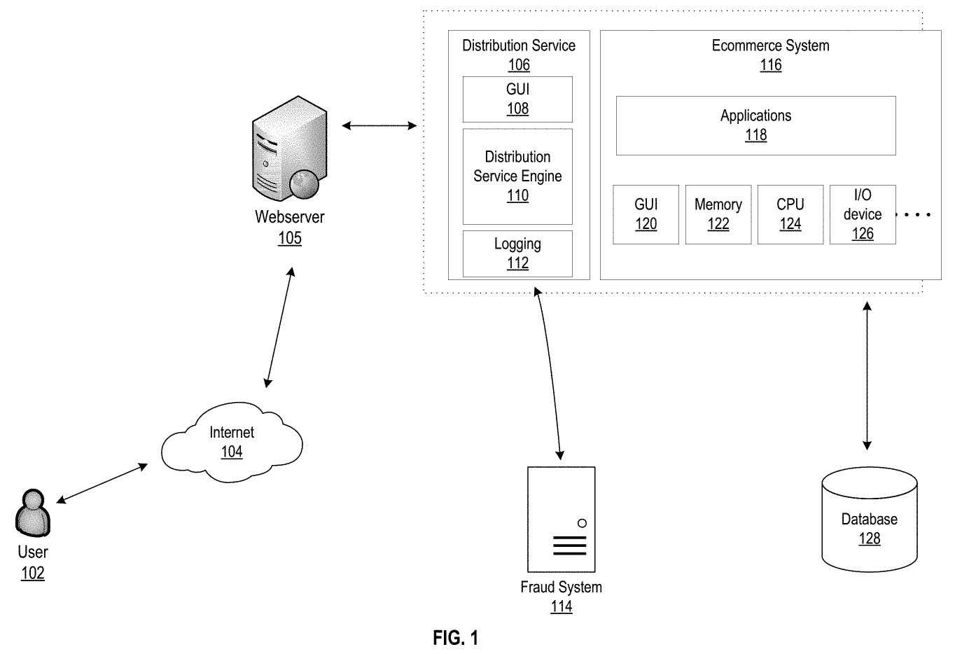

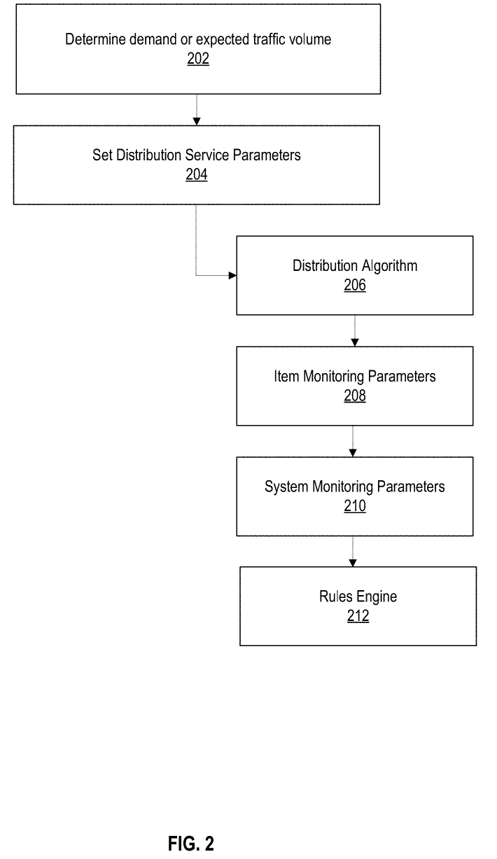

FIG. 1 illustrates a high-level flow diagram for high volume traffic handling for high demand, constrained products, which is discussed in further detail throughout this specification with respect to FIGS. 2 through 4. The system is designed to be light-weight and easily scalable into multiple regions. It may be implemented when a seller or backend commerce system determines that demand for a product or traffic to the system is particularly high. The product may or may not be limited, such as a product in limited release or preorder status, however, the benefits of the disclosed system and method are most fully realized when the product is a limited resource or a in a high-demand pre-order situation. For ease of description, embodiments will be described in terms of limited product availability, but this is not meant to limit the embodiment to that particular use.

Demand for a product may be determined by any forecasting method or algorithm. When the demand is expected to exceed a safe level of operation for any component of the ecommerce system, the product may be flagged for alternative processing and the disclosed system and method may be put into place, logically sitting in front of the ecommerce system, to protect the ecommerce system from the wall of traffic. Any subsequent requests for the high demand product or site are directed to the disclosed system. Alternatively, the traffic directed to a website selling high demand products may be monitored, at an ecommerce gateway load balancer, for example, and when high traffic or high demand may compromise the user experience or the integrity of the site or the ecommerce system, transactions for the product may be redirected to the disclosed system.

Referring to FIG. 1, many users 102 may access a web site 105 fronting an ecommerce system 116 for a high demand product via the internet 104. The ecommerce system may be a dedicated system associated only with the web site/merchant 105, or may be an ecommerce services provider. In practicing the disclosed embodiments, users reaching the site may be presented with an invitation request, or static web page form for the distribution service 106, rather than being immediately directed to the ecommerce system. The user 102 completes the page form 108 to indicate interest in purchasing the item, including basic information such as name, address, email address, other contact information and number of units desired, if the purchase of more than one is allowed. Completion of the form generates a confirmation email to the user 102 that the system has received the request. At the same time, high-speed logging of the request record 112 is performed by the distribution service engine 110. Basic duplicate checking may be performed as the record is added. Each record is timestamped to maintain the user's place in queue.

Log files 112 may be passed to a fraud system 114 on a predetermined schedule, typically in real time, or one minute or less. A light-weight fraud evaluation may be run on the entire dataset, merging/disqualifying records as it determines which, if any, records must be flagged or held for further investigation. For requests passing initial validation, an email may be automatically generated providing a means (such as a link) for the user to determine the status of a request.

The distribution service engine 110 monitors product inventory and the traffic volume at the ecommerce system 116. Monitoring the traffic volume allows the distribution service engine to determine how many orders may be placed during a given period, therefore spreading the demand on the system over time. The service issues time sensitive “tickets” to users based on a distribution algorithm. The ticket information may be transmitted to the user by email, or may be provided on a “check back later” page. The ticket provides a universal resource locator (URL) link for the user to access the ecommerce system to purchase the desired item(s) during a particular time period. If the user does not “validate” the ticket (place an order) during the designated time period, the ticket may expire. Inventory reserved for an expired ticket is freed for the next person in queue.

The user validates the ticket by accessing the link within the appointed time period. The link provides the user with access to the ecommerce system 116, where an order for the item may be placed. Orders are written to the database 128, an order confirmation page is displayed and/or email sent when the transaction is completed and the order fulfilled.

FIG. 2 illustrates steps required to prepare the service for operation. In the case of a high demand product anticipated high-volume traffic may be estimated using an evaluation of social media, marketing projections, or forecasting methods 202. If the expected traffic volume is greater than desired, or if the combination of high demand and low inventory may create a negative user experience, the distribution service may be installed or activated, logically in front of the ecommerce system. The distribution service engine parameters 204 may be set to accommodate the expected scenario and respond to changes in the system. In some embodiments, a distribution algorithm 206 may determine the optimal policy for distributing inventory to users, for example, by optimizing the distribution of available inventory in a limited-inventory system, with the distribution system responsible for implementing the determined policy. A distribution algorithm 206 may be very complex or very simple, with the goal of issuing the optimal number of tickets that may be validated within a certain time period in order to avoid high traffic assaults on the ecommerce system. The decision mechanism on issuing tickets is also time sensitive, allowing it to be expanded over time. Users who are given a ticket and fail to utilize it may be passed over/denied at a later time. The decision algorithm may also provide for a ‘pass-through’ situation where a user is allowed to pass through to the ecommerce system to place an order directly.

The number of tickets and time allotment should take overall system demand into account. The service must also enforce rules such as ensuring that tickets are not issued when there is no inventory and that a ticket is only claimed once, so inventory monitoring 208, ecommerce system monitoring 210 and an action/rule script, or other rules component 212 may be required.

Inventory monitoring 208 includes providing supply and tracking ticket utilization. An administrator may ‘open up’ supply into the system at any time, either piecemeal (a few thousand at a specific time), or a certain number per day, utilizing other algorithmic release mechanisms, or a supply/demand-generation system directly interacting with it. The system then picks via an algorithmic mechanism a collection of end-users and emails those people notifying them they have a time-sensitive ticket available to them. The system can monitor the overall demand, the number of tickets that have been sent (and the inventory units attached to them, if for multiple units), the number that have been validated, the number still in contention and the number fulfilled. The backend ecommerce system can query the service to validate the ticket, as well as to update the ticket when the end-user has used it. This prevents the ticket being used by more than the desired number of people.

The distribution service maintains a priority queue based on the time stamp. A service page may be provided for a user to check their request status, providing an estimation of where the request lies within the queue. The service may report on the top X requests in the queue. X may be a parameter that could be random, algorithmic or a designated number, such as the top 10, top 100, or top 1000. A generic message may be provided to prevent an end-user determining what the actual demand is, if the web merchant prefers to keep demand confidential. The service could also report on estimated delivery for the first thousand so that the requestors at the top.

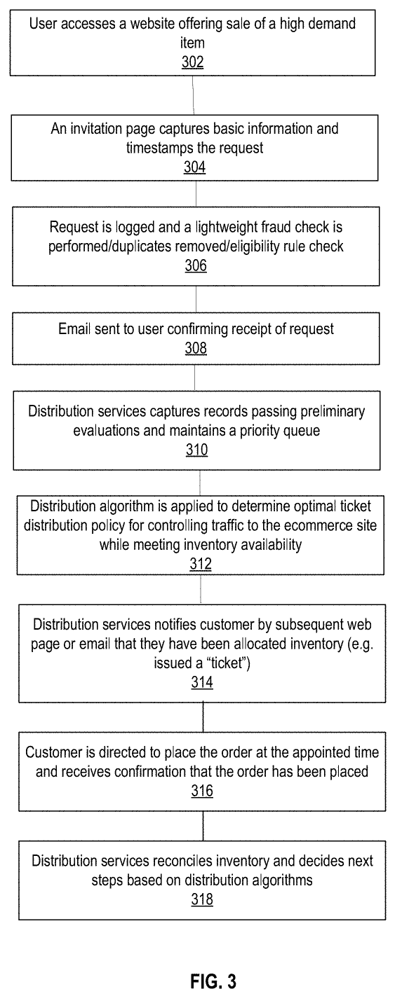

FIG. 3 illustrates an exemplary workflow consistent with embodiments of this invention. Uses access a website offering a high demand item 302. If high demand is expected or discovered, i.e. demand greater than will allow the system to continue to operate at normal levels, the distribution service is activated. The service presents an “invitation” form page 304, allowing a user to register interest in purchasing the item. The form collects basic information that allows a preliminary fraud check and timestamps the request. The request is logged and a lightweight fraud check is performed, duplicates are removed, and the page is evaluated for eligibility based on any rules configured in the service 306. An email may be sent indicating receipt of the request 308. In some embodiments, depending on the traffic coming into the ecommerce system, and inventory for the product, the user may be directed to the ecommerce system immediately. Those requests not passing the preliminary check are set aside. The requests passing preliminary evaluation are captured and maintained in a priority queue 310. The distribution algorithm is applied to the captured requests to determine the optimal ticket distribution policy for controlling traffic to the ecommerce site while meeting inventory availability 312. In other words, it determines when and at what rate orders may be placed in order to maintain an acceptable level of traffic hitting the ecommerce system. When inventory is available, distribution services notifies the customer by subsequent web page or email that they have been allocated inventory, or issued a “ticket” 314. The customer is directed where and when to place the order; once the order has been placed a confirmation email is sent to the customer 316 distribution services engine reconciles inventory, including validating whether and what tickets have been used or are still in contention and if any inventory has been added. The traffic levels may be evaluated and the engine decides the next steps based on the distribution algorithms 318.

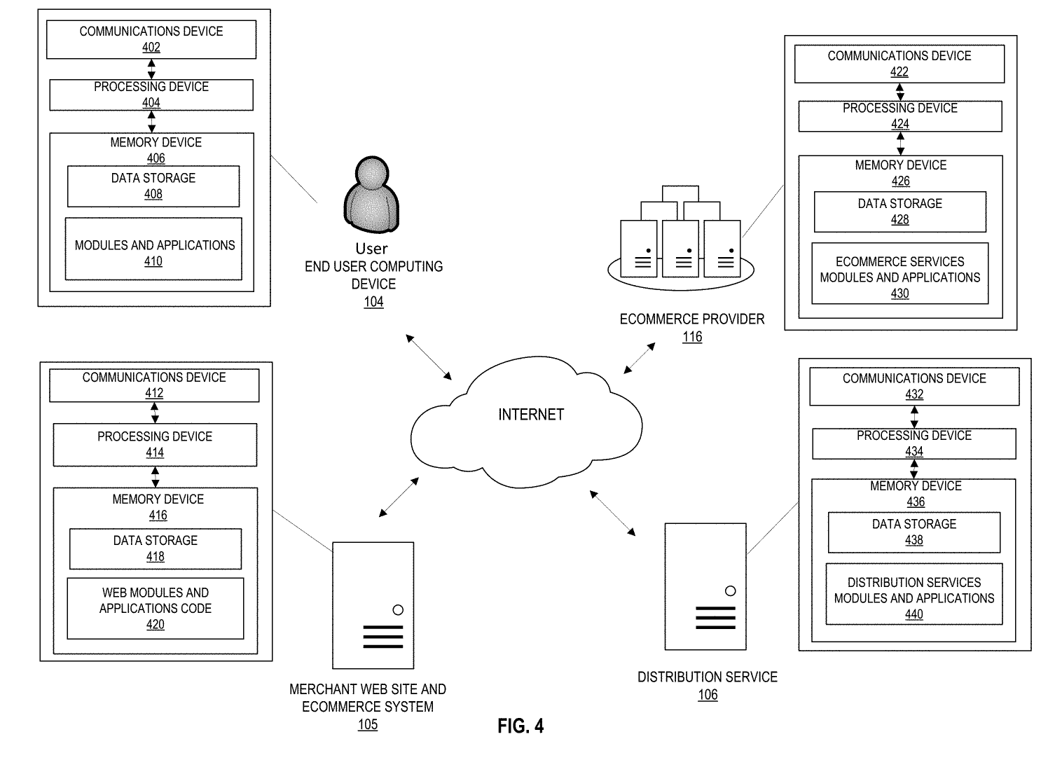

FIG. 4 illustrates the basic components of the computing devices used to practice an embodiment of the disclosed system and method. In some embodiments, users 102 use some type of computing device to access the internet and web pages in order to order products or services. The device may be any kind of internet-enabled device, including workstations, desktop computers, laptop computers, tablets, smart phones or other devices. Each would be equipped with some type of communications device 402, a processing device 404, memory 406, including data storage 408, random access memory and non-transitory storage for browsers, modules and application code 410, which when executed by the processor perform the functions required for a user to make an online purchase.

A merchant web site 105 offering products or services for sale generally resides on one or more server devices, each equipped with a communications device 412, a processing device 414, memory 416, including data storage 418, random access memory and non-transitory memory storage for serving web pages, maintaining product catalogs, and other functions required of a merchant site, including application code 420, which when executed by the processor perform the functions required for a merchant to provide an online store offering products or services to end users consistent with embodiments described herein.

A ecommerce service provider 116 may offer a full suite of modules for placing orders for end users shopping on merchant sites. They are generally highly distributed systems with multiple data centers located throughout the world, optimally configured to provide services to client web stores, such as fraud, payments, tax reconciliation and payment, catalog services, fulfillment and more. As was discussed previously these systems usually constructed from many server devices, and are tuned for a “normal” traffic load. Each server comprises a communications device 422, a processing device 424, a memory device 426 with data storage 428, random access memory and non-transitory memory storing ecommerce service modules and applications 430 comprising executable instructions, which when executed by the processor create a special purpose machine providing the services consistent with the embodiments described herein.

An ecommerce distribution service 106 enables users to indicate their interest in purchasing an item with huge demand, the traffic for which has the potential for inflicting serious impacts on the stability and health of the ecommerce service provider system. As discussed previously these systems are usually very light weight, likely comprising a number of servers with basic services, including, a distribution service and distribution service engine primarily comprised of a distribution algorithm for determining an optimal policy for metering traffic to the ecommerce system over time at a rate that will maintain its stability. Each server comprises a communications device 422, a processing device 424, a memory device 426 with data storage 428, random access memory and non-transitory memory storing ecommerce service modules and applications 430 comprising executable instructions, which when executed by the processor create a special purpose machine providing the services consistent with the embodiments described herein. Network connections allow the distribution service to access the ecommerce system for information such as traffic load, inventory levels, fraud algorithms for record processing, and more.

Further, individual components of the disclosed system and method are necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules are stored in memory for execution by a processor. The ecommerce application generally comprises application programming interfaces, a commerce engine, services, third party services and solutions and merchant and partner integrations. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs.

A secondary storage device may include a hard disk drive, floppy disk drive, CD-ROM drive, DVD-ROM drive, or other types of non-volatile data storage, and may correspond with the various equipment and modules shown in the figures. The secondary device could also be in the cloud. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a PC computer monitor, a laptop screen, a phone screen interface or flat-screen display. The output device may include any type of device for presenting a hard copy of information, such as a printer, and other types of output devices include speakers or any device for providing information in audio form.

Although the telecommunications device, computer, computing device or server has been described with various components, it should be noted that such a telecommunications device, computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be merchant or server computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

Client computers, computing devices and telecommunications devices access features of the system described herein using Web Services and APIs. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application, while maintaining substantially the same functionality without departing from the scope and spirit of the present invention.

What is claimed is:

1. A system for protecting an online ecommerce system from extraordinarily high traffic for a high demand product, the system comprising:
a first server associated with a website selling products or services of high demand, the server comprising a processor, memory, and computer instructions stored in memory which when executed by the processor perform the functions of offering products or services for purchase;
a second server associated with an ecommerce system, providing a full suite of ecommerce functions and configured for optimal performance at a normal rate of traffic, the server comprising a processor, memory, and computer instructions stored in memory which when executed by the processor perform the functions of the ecommerce system;
a third server associated with a distribution service logically placed in front of the ecommerce system during periods of very high traffic, the server comprising a processor, memory, and computer instructions stored in memory which when executed by the processor perform the method of metering traffic to the ecommerce system by:
receiving requests from a large number of users, the requests indicating user interest in purchasing a product for which expected traffic may exceed the performance limits of the second server;
capturing request information and subject it to preliminary processing;
employing a distribution algorithm to determine the number and time that the users may access the ecommerce system to place an order;
restricting the user to the allotted time in order to meter traffic into the ecommerce system at an acceptable rate.

2. The system of claim 1 where the second server further comprises a fraud module accessible to the third server in order to perform preliminary processing related to fraud.

3. A method for protecting an online ecommerce system from extraordinarily high traffic for a high demand product, the method comprising:
receiving requests from a large number of users, the requests indicating user interest in purchasing a product for which expected traffic may exceed the performance limits of the second server;
capturing request information and subject it to preliminary processing;
employing a distribution algorithm to determine the number and time that the users may access the ecommerce system to place an order;
restricting the user to the allotted time in order to meter traffic into the ecommerce system at an acceptable rate.

4. The method of claim 3 wherein preliminary processing includes removing duplicate records and doing a preliminary fraud evaluation.

5. The method of claim 3 wherein the distribution service is operatively configured to monitor inventory and the traffic approaching the ecommerce system.
